(19) United States
(12) Patent Application Publication
(10) Pub. No.: US 2008/0133632 A1
(43) Pub. Date: Jun. 5, 2008

(54) APPARATUS AND METHOD FOR COMPARING PROTEIN STRUCTURES USING PRINCIPAL COMPONENTS ANALYSIS AND AUTOCORRELATION

(76) Inventors: Dae-Hee KIM, Daejon (KR); Sung-Hee PARK, Daejon (KR); Chan-Yong PARK, Daejeon (KR); Soo-Jun PARK, Seoul (KR); Seon-Hee PARK, Daejon (KR)

Correspondence Address: LADAS & PARRY LLP, 224 SOUTH MICHIGAN AVENUE, SUITE 1600, CHICAGO, IL, 60604, US

(21) Appl. No.: 11/877,150

(22) Filed: Oct. 23, 2007

(30) Foreign Application Priority Data
Dec. 4, 2006 (KR) 10-2006-0121752

(51) Int. Cl. G06F 17/14; G06F 17/15

(52) U.S. Cl. 708/404; 708/422

(57) ABSTRACT

Provided is an apparatus and method for comparing structures of proteins by extracting main axes of the proteins using principal components analysis (PCA), dividing regions using grids into voxels for precise structure alignment, and placing the proteins respectively in the regions to calculate a similarity between the proteins by autocorrelation. The apparatus for comparing protein structures using principal components analysis (PCA) and autocorrelation includes: a PCA calculator for receiving a query protein for extracting a main axis of the query protein; a voxel generator for receiving information about the main axis from the PCA calculator and dividing a predetermined region using a grid to determine whether the divided region is occupied by the query protein for generating voxels of the query protein; and a comparison processor for performing an autocorrelation calculation between voxels of one protein and voxels of the other protein that are generated by the voxel generator.

### CROSS-REFERENCE(S) TO RELATED APPLICATIONS

The present invention claims priority of Korean Patent Application No. 10-2006-0121752, filed on Dec. 4, 2006, respectively, which is incorporated herein by reference.

### BACKGROUND OF THE INVENTION

1. Field of the Invention

The present invention relates to an apparatus and method for comparing structures of proteins to measure a similarity between the proteins by using the fact that similar proteins have similar functions; and, more particularly, to an apparatus and method for comparing structures of proteins by assuming that the proteins composed of atoms have unique three-dimensional shapes to extract characteristics of the shapes of the proteins using principal components analysis (PCA), and dividing three-dimensional regions including the proteins to precisely calculate a similarity between the structures of the proteins by autocorrelation.

This work was supported by the Information Technology (IT) research and development program of the Korean Ministry of Information and Communication (MIC) and/or the Korean Institute for Information Technology Advancement (IITA) [2005-S-008-02, “SW Component Development of Bio Data Mining & Integrated Management”].

2. Description of Related Art

A number of protein structure comparison methods have been proposed to provide a way of searching for similar proteins. It takes much time to compare two protein structures in three-dimensional space due to difficulties in structure alignment and a large amount of calculation caused by the characteristics of three-dimensional analysis.

In early methods, a similarity between two proteins is calculated using the positions of protein atoms and the distances between the protein atoms. However, the early methods are disadvantageous since they require a large amount of calculation and are sensitive to errors. To address these problems, a method of calculating a similarity between two proteins using only the positions of alpha carbons of the proteins has been proposed. Such a method is disclosed in L. Holm and C. Sander: “Protein Structure Comparison by alignment of distance matrix”, Journal of Molecular Biology, 1993 (hereinafter, referred to as a first article).

In general, the structures of proteins are compared using the distances between atoms of proteins. A protein structure comparison method (known as “DALI”) disclosed in the first article provides a way of comparing protein structures using a distance matrix. In detail, the distances between atoms of two proteins are expressed by distance matrixes, and structures of the two proteins are compared by calculating a similarity between the distance matrixes of the two proteins. Here, the distance matrixes are made using distances between alpha carbons of the proteins representing residues instead of using distances of all atoms of the proteins. The distance matrixes represent distances between alpha carbons of proteins. In detail, the distance matrix is a square matrix of which rows and columns represent alpha atoms of a protein and entries represent the distances between the alpha atoms. Thus, the distance matrix is a symmetric matrix of which all diagonal entries are zero.

The distance matrix is divided into small matrixes such as hexapeptide-hexapeptide 6×6 sub-matrixes. While comparing sub-matrixes of distance matrixes of two proteins, the sub-matrixes are re-combined in a manner such that the two distance matrixes have maximum identical or similar sub-matrixes. In this way, the two proteins are aligned. According to the method of the first article, optimal pairwise protein structure alignment is possible.

However, the method of the first article is disadvantageous since it takes much time to compare the distances of atoms of two proteins and re-combine the sub-matrixes.

Meanwhile, according to another method of aligning protein structures, secondary structures of proteins as well as atomic-level distances of the proteins are compared. Such a method is disclosed in Amit P. Singh and Douglas L. Brutlag: “Hierarchical Protein Structure Superposition using both Secondary Structure and Atomic Representation”, Proc. Intelligent Systems for Molecular Biology, 1997 (hereinafter, referred to as a second article).

The second article provides a protein structure alignment algorism known as “LOCK”. Although the proceeding methods provide a way of aligning protein structures in the atomic level, the LOCK algorism provides a way of aligning proteins structures in consideration of secondary structures and atomic-level distances of the proteins. In a first step, the secondary structures of two proteins are expressed using vectors, and the secondary structures are compared using seven scoring functions.

The resulting seven values are applied to a dynamic programming algorithm for optimal local alignment. In a second step, while maintaining the secondary-structure alignment of the two proteins, the two proteins are aligned using coordinates of atoms of the proteins in a manner such that the distances between the atoms of the two proteins can be minimized. The method of the second article considers the secondary structures of proteins so that precise alignment can be possible after large-scale alignment.

However, the method of the second article is disadvantageous since it requires much time.

Therefore, there is an increasing need for an apparatus and method for rapidly comparing protein structures and calculating a similarity between the protein structures.

### SUMMARY OF THE INVENTION

An embodiment of the present invention is directed to providing an apparatus and method for comparing protein structures using geographic shapes of the protein structures to measure a similarity between the protein structures.

Another embodiment of the present invention is directed to providing an apparatus and method for comparing structures of proteins by extracting main axes of the proteins using principal components analysis (PCA), dividing regions using grids into voxels for precise structure alignment, and placing the proteins respectively in the regions to calculate a similarity between the proteins by autocorrelation.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided an apparatus for comparing protein structures using principal components analysis (PCA) and autocorrelation, the apparatus which includes: a PCA calculator for receiving a query protein for extracting a main axis of the query protein; a voxel generator for receiving information about the main axis from the PCA calculator and dividing a predetermined region using a grid to determine whether the divided region is occupied by the query protein for generating voxels of the query protein; and a comparison processor for performing an autocorrelation calculation between voxels of one protein and voxels of the other protein that are generated by the voxel generator.

In accordance with another aspect of the present invention, there is provided a method for comparing protein structures using PCA and autocorrelation, the method which includes the steps of: a) extracting main axes from query proteins by PCA; b) generating voxels of the query proteins by dividing predetermined regions into sections according to information about the main axes and determining whether the respective sections are occupied by the query proteins; and c) calculating a similarity between query proteins by performing an autocorrelation calculation between voxels of one protein and voxels of the other protein.

In the apparatus and method for rapidly comparing protein structures according to the present invention, main axes of a target protein are extracted by PCA, and eight basic shapes of the protein are modeled using three main axes extracted from the protein so that demerits of PCA can be obviated. Furthermore, proteins are precisely aligned by autocorrelation so that demerits of a protein structure alignment method using main axes and center points of the proteins can be obviated. In addition, the autocorrelation is performed using fast Fourier transform (FFT) for the purpose of increasing calculation speed.

### BRIEF DESCRIPTION OF THE DRAWINGS

FIG. 1 illustrates an apparatus for comparing protein structures using principal components analysis (PCA) and autocorrelation in accordance with an embodiment of the present invention.

FIG. 2A illustrates examples of first and second main axes obtained by PCA in accordance with an embodiment of the present invention.

FIG. 2B illustrates other examples of first and second main axes having the same directions as those of the first and second main axes of FIG. 2A.

FIG. 3 illustrates alignment procedures using PCA in accordance with an embodiment of the present invention.

FIG. 4A illustrates an example of a 90×90×90 region in accordance with an embodiment of the present invention.

FIG. 4B illustrates an example of a two-dimensional region in accordance with an embodiment of the present invention.

FIG. 5 illustrates an example of an autocorrelation process in accordance with an embodiment of the present invention.

FIG. 6 illustrates an example of optimally aligned proteins by the autocorrelation process of FIG. 5, in accordance with an embodiment of the present invention.

FIG. 7 is a flowchart for explaining a method for comparing protein structures using PCA and autocorrelation in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

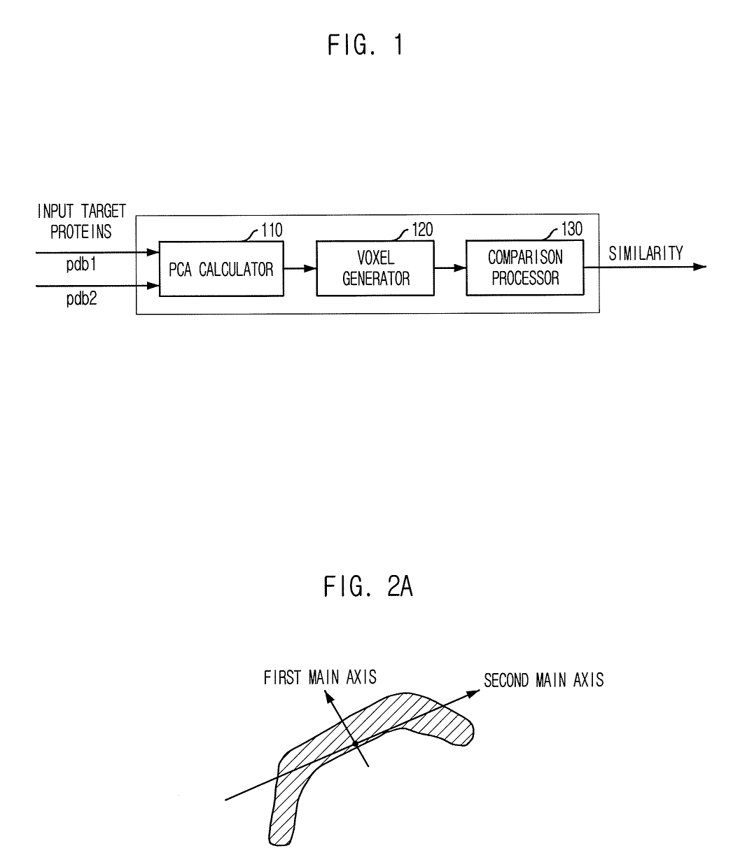

FIG. 1 illustrates an apparatus for comparing protein structures using principal components analysis (PCA) and autocorrelation in accordance with an embodiment of the present invention.

Referring to FIG. 1, the apparatus of the present invention is used for comparing protein structures using PCA and autocorrelation. The apparatus includes a PCA calculator 110, a voxel generator 120, and a comparison processor 130. The PCA calculator 110 receives a query protein from an external source (a user) and extracts main axes from the query protein. The voxel generator 120 generates voxels by receiving information about the main axes from the PCA calculator 110, dividing a region including the query protein into voxels, and determining whether the respective voxels are occupied by the protein. The comparison processor 130 performs an autocorrelation calculation on voxels of proteins generated by the voxel generator 120 to calculate a similarity between the voxels.

In detail, the PCA calculator 110 receives two proteins from an external source and generates basic shapes in consideration of eight directions by extracting main axes from the two proteins using information (e.g., coordinate information) about the two proteins. Thereafter, the PCA calculator 110 outputs the basic shapes to the voxel generator 120.

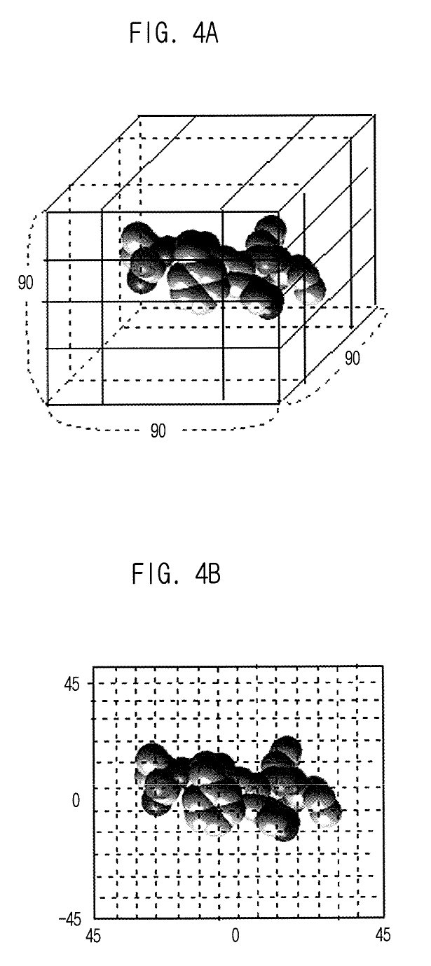

Then, the voxel generator 120 generates voxels. In detail, the voxel generator 120 divides regions including the proteins received from the PCA calculator 110 into voxels using grids and allocating values to the voxels depending on whether the respectively voxels are occupied by the proteins. Thereafter, the voxel generator 120 outputs the voxels to the comparison processor 130. Here, the grid means a lattice used for dividing the region into the voxels as shown in FIG. 4A, the voxels mean the divided sections of the region including the protein.

The comparison processor 130 performs an autocorrelation calculation on the voxels of the two proteins to calculate a similarity between the two proteins. Here, the autocorrelation means a calculation performed to determine how much the two proteins are correlated with each other. For example, multiplication calculation can be performed on voxels having corresponding coordinates and a value of 1 or 0 as the autocorrelation.

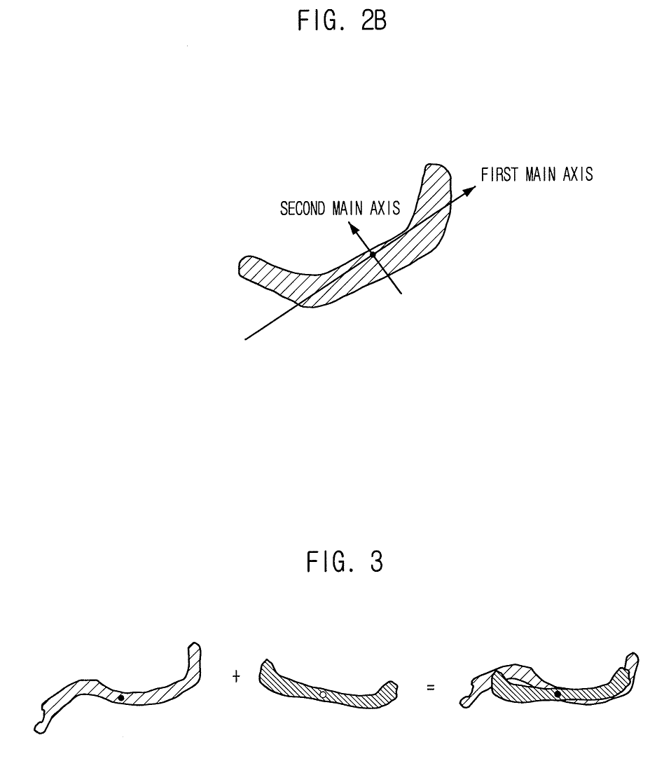

Next, an exemplary structure and operation of the apparatus for comparing protein structures using PCA and autocorrelation will now be described in detail with reference to FIGS. 2A through 7.

FIG. 2A illustrates examples of first and second main axes obtained by PCA according to an embodiment of the present invention.

FIG. 2A is an exemplary two-dimensional view illustrating first and second main axes calculated by PCA according to an embodiment of the present invention. When a protein data bank (PDB) file (a protein) is input, three vectors are calculated as main axes of the protein by performing PCA on coordinates of all atoms of the proteins.

Coordinates of the atoms of the protein can be expressed by static points P₁, P₂, P₁, P₃, . . . , P_{N}, where N is a natural number, and Pᵢ=(xᵢ, yᵢ, zᵢ).

The mean position m of the static points P₁, P₂, P₁, P₃, . . . , P_{N} is calculated using Eq. 1 below, a 3×3 covariance matrix C is obtained using Eq. 2 below. An eigenvector of the covariance matrix C is calculated to obtain a transformation matrix A for structure alignment. For this, roots of Eq. 3 are calculated as eigenvalues λ₁, λ₂, and λ₃. The eigenvalues λ₁, λ₂, and λ₃ are input to Eq. 4 below in the order of λ₁>λ₂>λ₃ to calculate three eigenvectors V₁, V₂, and V₃. The three eigenvectors V₁, V₂, and V₃ are calculated as the main axes of the protein. A 3×3 transformation matrix A is defined by Eq. 5. When an alignment calculation is performed, Pᵢ is transformed by the matrix A as shown in Eq. 6, and the center point of the protein is moved to an origin of a predetermined region.

$$\begin{matrix}m = \frac{1}{N} {\sum }_{i = 1}^{N} {P}_{i} , & Eq . 1 \\ C = \frac{1}{N} {\sum }_{i = 1}^{N} ( {P}_{i} - m ) {( {P}_{i} - m )}^{T} & Eq . 2\end{matrix}$$

where N denotes the number of static points

det(C−λI)=0, where det denotes determinant Eq. 3

$$\begin{matrix}( C - λ I ) {V}_{i} = 0 & Eq . 4 \\ A = ( \frac{{V}_{1}}{‖ {V}_{1} ‖} , \frac{{V}_{2}}{‖ {V}_{2} ‖} , \frac{{V}_{3}}{‖ {V}_{3} ‖} ) & Eq . 5 \\ {P}_{i} = {P}_{i} * A - m & Eq . 6\end{matrix}$$

FIG. 2B illustrates other examples of first and second main axes having the same directions as those of the first and second main axes of FIG. 2A.

Referring to FIGS. 2A and 2B, although the main axes of the protein of FIG. 2B have the same directions as the main axes of the protein of FIG. 2A, desired results cannot be obtained since the proteins have different shapes. For this reason, all main axis directions are considered to calculate matrixes A₀, A₁, A₂, A₃, A₄, A₅, A₆, and A₇ from the transformation matrix A of Eq. 5 by using the fact that eigenvectors are orthogonal to each other as shown in Eq. 7 below.

$${A}_{0} = A = ( \frac{{V}_{1}}{‖ {V}_{1} ‖} , \frac{{V}_{2}}{‖ {V}_{2} ‖} , \frac{{V}_{3}}{‖ {V}_{3} ‖} ) , \\ {A}_{1} = ( - \frac{{V}_{1}}{‖ {V}_{1} ‖} , \frac{{V}_{2}}{‖ {V}_{2} ‖} , \frac{{V}_{3}}{‖ {V}_{3} ‖} ) , \\ {A}_{2} = ( \frac{{V}_{1}}{‖ {V}_{1} \vert} , - \frac{{V}_{2}}{‖ {V}_{2} ‖} , \frac{{V}_{3}}{‖ {V}_{3} ‖} ) , \\ {A}_{3} = ( - \frac{{V}_{1}}{‖ {V}_{1} ‖} , - \frac{{V}_{2}}{‖ {V}_{2} ‖} , \frac{{V}_{3}}{‖ {V}_{3} ‖} ) , \\ {A}_{4} = ( \frac{{V}_{1}}{‖ {V}_{1} ‖} , \frac{{V}_{2}}{‖ {V}_{2} ‖} , - \frac{{V}_{3}}{‖ {V}_{3} ‖} ) , \\ {A}_{5} = ( - \frac{{V}_{1}}{‖ {V}_{1} ‖} , \frac{{V}_{2}}{‖ {V}_{2} ‖} , - \frac{{V}_{3}}{‖ {V}_{3} ‖} ) , \\ {A}_{6} = ( \frac{{V}_{1}}{‖ {V}_{1} ‖} , - \frac{{V}_{2}}{‖ {V}_{2} ‖} , - \frac{{V}_{3}}{‖ {V}_{3} ‖} ) , \\ {A}_{7} = ( - \frac{{V}_{1}}{‖ {V}_{1} ‖} , - \frac{{V}_{2}}{‖ {V}_{2} ‖} , - \frac{{V}_{3}}{‖ {V}_{3} ‖} ) \qquad Eq . 7$$

FIG. 3 illustrates alignment procedures using PCA in accordance with an embodiment of the present invention.

Referring to FIG. 3, two proteins are aligned to overlap each other by using main axes obtained by PCA. A main axis is extracted based on a center point of a target object by the PCA, such that the center points of the two proteins can be aligned with each other as shown in FIG. 3.

FIG. 4A illustrates an example of a 90×90×90 region in accordance with an embodiment of the present invention. Referring to FIG. 4A, a region is divided into 90×90×90 sections (voxels), and the center of a protein is moved to an origin of the region. In this way, 90×90×90 voxels in which a protein is placed can be generated.

FIG. 4B illustrates an example of a two-dimensional region in accordance with an embodiment of the present invention.

Since data of a protein data bank (PDB) file (a protein) usually occupies coordinates from −45 Å to +45 Å, a two-dimensional image of FIG. 4B can be obtained when the center of an input protein is moved to an origin of a region. Referring to FIG. 4B, the region is divided into 90×90×90 sections (voxels) using a grid, and it is determined whether each voxel of the region is occupied by a protein using diameters of atoms of the protein. Then, data are allocated to the 90×90×90 voxels of the regions using Eq. 8 below. In this way, voxels having a value of 0 or 1 are generated.

$$Celldata = \{ \begin{matrix}1 \text{:} when voxel is occupied by a protein \\ 0 \text{:} when voxel is not occupied by a protein\end{matrix} \qquad Eq . 8$$

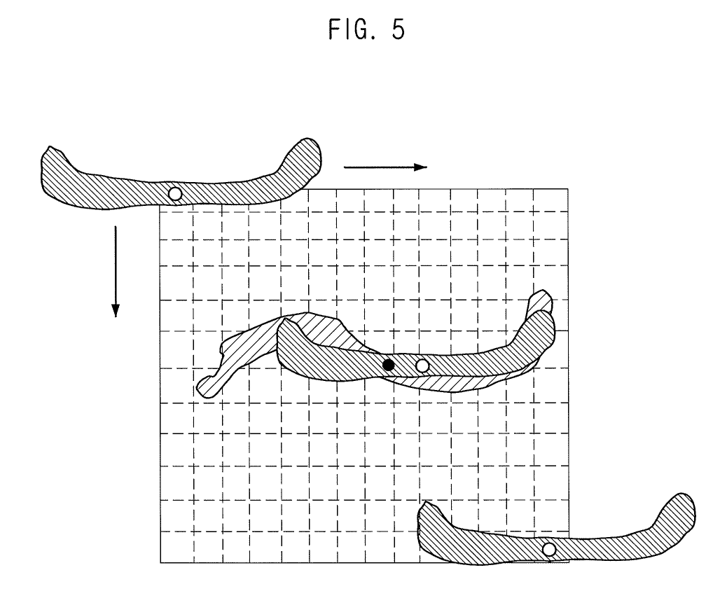

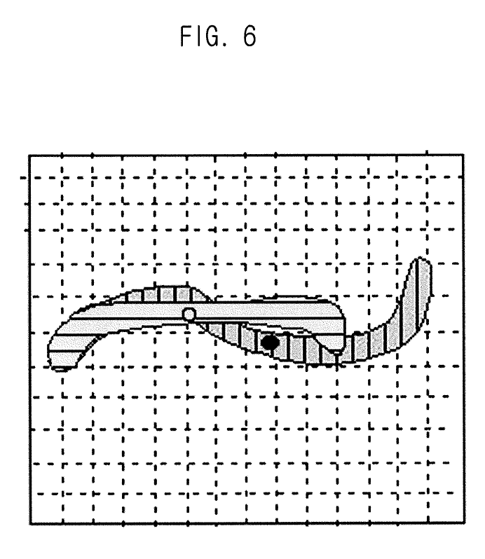

FIG. 5 illustrates an example of an autocorrelation process in accordance with an embodiment of the present invention, and FIG. 6 illustrates an example of optimally aligned proteins by the autocorrelation process of FIG. 5, in accordance with an embodiment of the present invention.

Referring to FIG. 5, the autocorrelation process is performed using voxels generated as described above to detect the degree of overlap between two proteins. In detail, PCA is performed on the two proteins, and autocorrelation is performed on the two proteins while moving the center of each protein from a point (0,0,0) to a point (90, 90, 90). Then, the two proteins are optimally aligned with each other at a position where the centers of the two proteins are not aligned. Referring to FIG. 6, when one of the proteins is turned upside down, the two proteins can be optimally aligned. Therefore, precise comparison alignment calculation is performed by PCA using main axes and center points of the proteins. Furthermore, to increase the speed of autocorrelation calculation, the autocorrelation calculation is performed using fast Fourier transform (FFT) as shown in Eq. 9 below.

FFT(g★h)=GH*

g★h=FFT⁻¹(GH*) Eq. 9

In Eq. 9, ★ denotes an autocorrelation calculation, FFT⁻¹ denotes inverse FFT, G denotes the result of FFT(g), and H denotes the result of FFT(h). Further, * denotes a conjugate complex number.

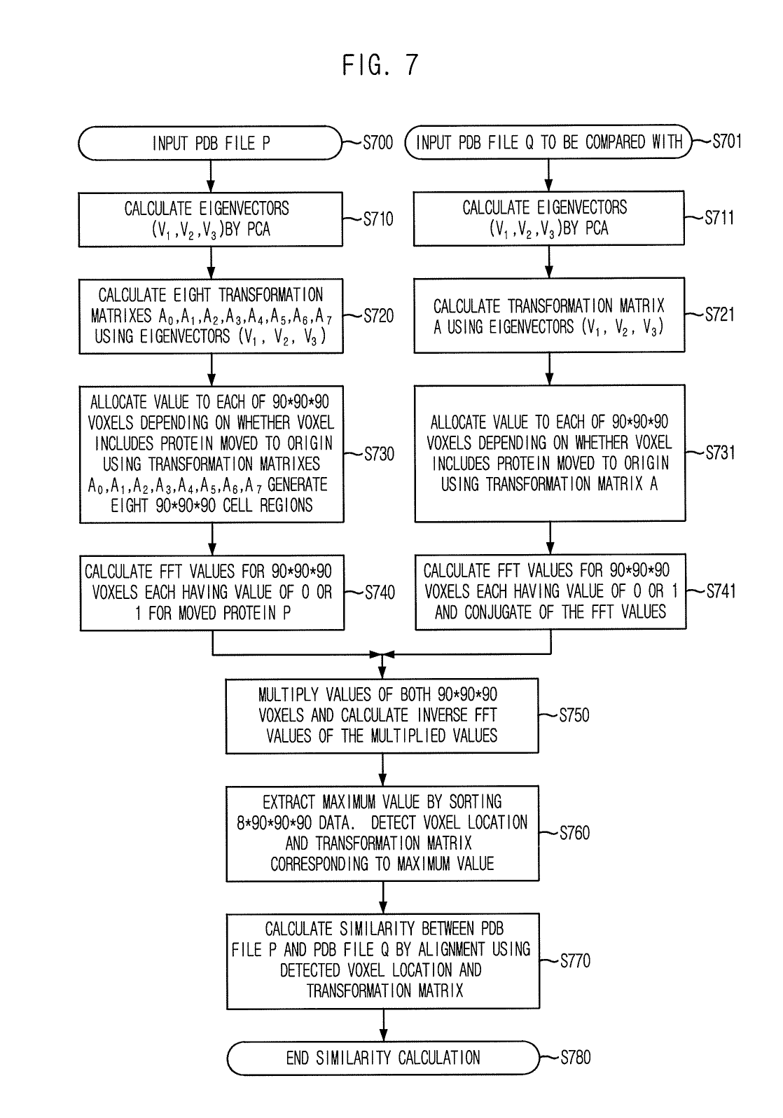

FIG. 7 is a flowchart for explaining a method for comparing protein structures using PCA and autocorrelation in accordance with an embodiment of the present invention.

In steps S700 and S701, a PDB file P (a protein P) including coordinate information is input, and a PDB file Q (a protein Q) including coordinate information is input to be compared with the PDB file P. In steps S710 and S711, eigenvectors (V₁, V₂, V₃) are calculated for PDB file P by PCA, and eigenvectors (V₁, V₂, V₃) are calculated for PDB file Q by PCA.

In step S720, eight transformation matrixes A₀, A₁, A₂, A₃, A₄, A₅, A₆, and A₇ are calculated using the eigenvectors (V₁, V₂, V₃) of the PDB file P in consideration of eight directions of the eigenvectors (V₁, V₂, V₃). In step S721, a transformation matrix A is calculated using original eigenvectors for the PDB file Q.

In step S730, new eight coordinates of the protein P are obtained by moving the protein P to an origin using the eight transformation matrixes A₀, A₁, A₂, A₃, A₄, A₅, A₆, and A₇, respectively. Then, the moved protein P is located within a region divided into 90×90×90 voxels, and it is determined whether each voxel is occupied by an atom of the protein P using the diameter of the atom in order to allocate each voxel 1 or 0 depending on the determined result.

Herein, even a small portion of a voxel is occupied by an atom of the protein P, 1 is allocated to the voxel. In this way, eight sets of 90×90×90 voxels are generated. In step S731, similar procedures are performed on the protein Q to generate a sing set of 90×90×90 voxels each allocated 1 or depending on whether the voxel is occupied by an atom of the protein Q. That is, in step S731, one transformation matrix A is used.

In step S740, FFT calculation is performed on the eight sets of 90×90×90 voxels each having a value of 1 or 0. In step S741, FFT calculation is performed on the single set of 90×90×90 voxels each having a value of 1 or 0, and the resulting complex number of each of the 90×90×90 voxels is replaced with the conjugate of the complex number.

In step S750, the values of 90×90×90 voxels obtained by the FFT calculation in step S740 are multiplied by the counterpart values of the 90×90×90 voxels obtained by the FFT calculation and conjugation in step S741, respectively, in order to generate 90×90×90 voxel data. Then, inverse FFT is performed on the 90×90×90 voxel data to generate 90×90×90 voxels each having the resulting value.

Step S750 is performed on the eight sets of 90×90×90 voxels, respectively. In step S760, the voxel values of the eight sets of 90×90×90 voxel are sorted to determine the maximum value, and the position of a voxel having the maximum value and the transformation matrix applied to the protein P for resulting in the voxel having the maximum value are determined.

In step S760, the position of the voxel having the maximum value relates to the movement of the center point of the protein P, and the determined transformation matrix relates with main axis directions of the protein P since the transformation matrix is obtained from eigenvectors representing the main axes of the protein P.

In step S770, the position of the voxel and the transformation matrix determined in step s760 are applied to the protein P for performing PCA on the protein P, and then the protein P is aligned with the protein Q to detect how many voxels of the 90×90×90 voxels of the protein P are overlapped with voxels of the protein Q so as to calculate the similarity between the protein P and the protein Q.

Here, the similarity between the proteins P and Q can be calculated using Eq. 10 below.

$$MIN ( \frac{the number of overlapped voxels}{the number of voxels of protein P} , \frac{the number of overlapped voxels}{the number of voxels of protein Q} ) \qquad Eq . 10$$

When one protein is included in the other protein because of size, it can be difficult to determine a similarity between the two proteins. In this case, the number of overlapped voxels can be calculated based on the bigger protein using Eq. 10.

According to the present invention, two proteins are first aligned in a three-dimensional space by PCA using coordinates of atoms of the two proteins, and then a similarity between the two proteins is calculated in consideration of interest directions and center point movement.

In other words, according to the present invention, main axes of target proteins are extracted by PCA using coordinates of the proteins, regions are divided using grids into voxels for precise structure alignment, and the proteins are respectively placed in the regions to calculate a similarity between the proteins by autocorrelation.

Furthermore, according to the present invention, PCA is used for aligning proteins, and FFT is used for autocorrelation calculation. Therefore, protein structures can be rapidly compared.

The methods in accordance with the embodiments of the present invention can be realized as programs and stored in a computer-readable recording medium that can execute the programs. Examples of the computer-readable recording medium include CD-ROM, RAM, ROM, floppy disks, hard disks, magneto-optical disks and the like.

While the present invention has been described with respect to the specific embodiments, it will be apparent to those skilled in the art that various changes and modifications may be made without departing from the spirit and scope of the invention as defined in the following claims.

What is claimed is:

1. An apparatus for comparing protein structures using principal components analysis (PCA) and autocorrelation, the apparatus comprising:
a PCA calculator for receiving a query protein for extracting a main axis of the query protein;
a voxel generator for receiving information about the main axis from the PCA calculator and dividing a predetermined region using a grid to determine whether the divided region is occupied by the query protein for generating voxels of the query protein; and
a comparison processor for performing an autocorrelation calculation between voxels of one protein and voxels of the other protein that are generated by the voxel generator.

2. The apparatus of claim 1, wherein the comparison calculator performs the autocorrelation calculation using fast Fourier transform (FFT).

3. The apparatus of claim 2, wherein the comparison calculator performs the autocorrelation calculation based on FFT calculation expressed as:
FFT(g★h)=GH*
g★h=FFT⁻¹(GH*)
where ★ denotes an autocorrelation calculation, FFT⁻¹ denotes inverse FFT, G denotes a result of FFT(g), H denotes a result of FFT(h), and * denotes a conjugate complex number.

4. The apparatus of claim 1, wherein the PCA calculator receives first and second proteins and extracts main axes from the first and second proteins using information about the first and second proteins so as to generate basic shapes of the first and second proteins and output the basic shapes to the voxel generator.

5. The apparatus of claim 4, wherein the PCA calculator generates the basic shapes in consideration of eight directions and outputs the basic shapes to the voxel generator.

6. The apparatus of claim 4, wherein the voxel generator divides predetermined regions respectively including the first and second proteins received from the PCA calculator into sections using grids and allocates each section a predetermined value depending on whether the section is occupied by an atom of the first and second proteins so as to generate voxels of the first protein and voxels of the second protein.

7. The apparatus of claim 6, wherein the comparison calculator calculates a similarity between the first and second proteins based on an equation expressed as:
$$MIN ( \frac{the number of overlapped voxels}{the number of voxels of first protein} , \frac{the number of overlapped voxels}{the number of voxels of second protein} )$$

8. A method for comparing protein structures using PCA and autocorrelation, the method comprising the steps of:
a) extracting main axes from query proteins by PCA;
b) generating voxels of the query proteins by dividing predetermined regions into sections according to information about the main axes and determining whether the respective sections are occupied by the query proteins; and
c) calculating a similarity between query proteins by performing an autocorrelation calculation between voxels of one protein and voxels of the other protein.

9. The method of claim 8, wherein the autocorrelation calculation in the step c) is performed using FFT.

10. The method of claim 9, wherein the autocorrelation calculation in the step c) is performed based on a FFT calculation expressed as:
FFT(g★h)=GH*
g★h=FFT⁻¹(GH*)
where ★ denotes an autocorrelation calculation, FFT⁻¹ denotes inverse FFT, G denotes a result of FFT(g), H denotes a result of FFT(h), and * denotes a conjugate complex number.

11. The method of claim 8, wherein the step a) includes the step of a1) extracting main axes from first and second proteins using information about the first and second proteins so as to generate basic shapes of the first and second proteins.

12. The method of claim 11, wherein the step a1) includes the step of generating basic shapes of the first and second proteins in consideration of eight directions.

13. The method of claim 11, wherein the step b) includes the steps of:
b1) dividing predetermined regions respectively including the first and second proteins into sections according to information about the main axes; and
b2) allocating each section a predetermined value depending on whether the section is occupied by an atom of the first and second proteins so as to generate voxels of the first protein and voxels of the second protein.

14. The method of claim 13, wherein the step c) includes the step of calculating a similarity between the first and second proteins based on an equation expressed as:
$$MIN ( \frac{the number of overlapped voxels}{the number of voxels of first protein} , \frac{the number of overlapped voxels}{the number of voxels of second protein} )$$
